(19) United States
(12) Patent Application Publication
(10) Pub. No.: US 2008/0054015 A1
(43) Pub. Date: Mar. 6, 2008

(54) Method and Apparatus for Pay Per Use and Revenue Sharing for Liquid Dispensing

(75) Inventor: Nick Moezidis, San Jose, CA (US)

Correspondence Address: HEIMLICH LAW, 5952 DIAL WAY, SAN JOSE, CA, 95129, US

(73) Assignee: Napa Technology, LLC, Santa Clara, CA (US)

(21) Appl. No.: 11/846,014

(22) Filed: Aug. 28, 2007

Related U.S. Application Data
(60) Provisional application No. 60/823,967, filed on Aug. 30, 2006.

(51) Int. Cl. G01F 11/00; B67D 5/10; B67D 1/08; B65D 83/00

(52) U.S. Cl. 222/1; 222/152; 222/2; 222/394

(57) ABSTRACT

A method and apparatus for a pay per use and revenue sharing for liquid dispensing have been disclosed.

### RELATED APPLICATION

This patent application claims priority of U.S. Provisional Application Ser. No. 60/823967 filed Aug. 30, 2006 titled “Method and Apparatus for Pay Per Use and Revenue Sharing for Liquid Dispensing”, which is hereby incorporated herein by reference.

### FIELD OF THE INVENTION

The present invention pertains to liquid dispensing. More particularly, the present invention relates to a method and apparatus for pay per use and revenue sharing for liquid dispensing.

### BACKGROUND OF THE INVENTION

Dispensing of liquids that may be consumed by humans has the potential for misappropriation as well as not being paid for. This presents a problem.

Dispensing of liquids, such as wine, which may be costly, may be prone to error in the volume dispensed. This presents a problem.

### BRIEF DESCRIPTION OF THE DRAWINGS

The invention is illustrated by way of example and not limitation in the figures of the accompanying drawings in which:

FIG. 1 illustrates an environment in which the method and apparatus of the invention may be used;

FIG. 2 is a block diagram of a computer system which may be used for implementing some embodiments of the invention;

FIGS. 3-42 illustrate various embodiments of the invention.

### DETAILED DESCRIPTION

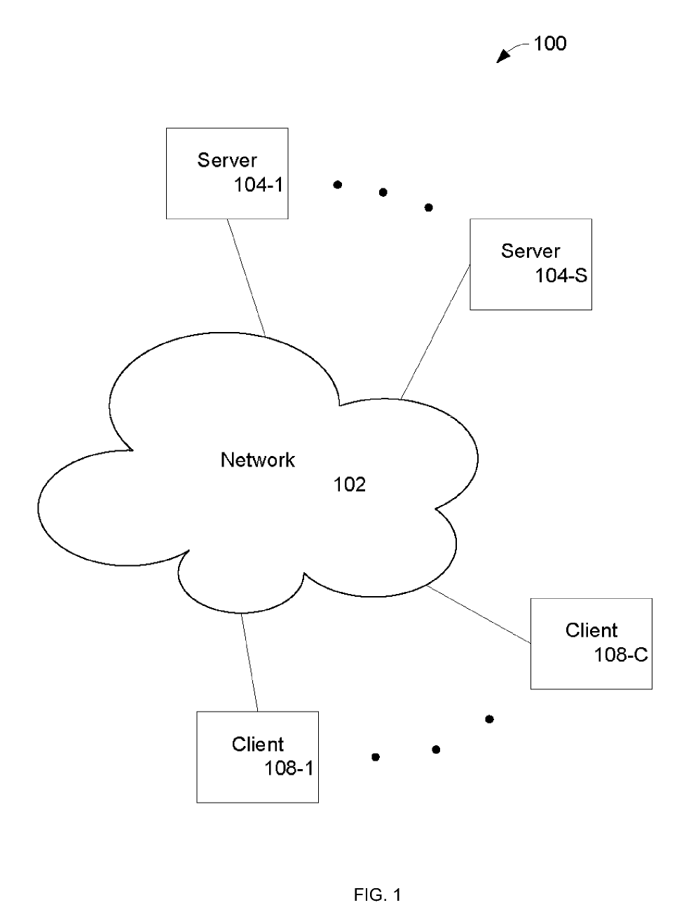

FIG. 1 illustrates a network environment 100 in which the techniques described may be applied. The network environment 100 has a network 102 that connects S servers 104-1 through 104-S, and C clients 108-1 through 108-C. More details are described below.

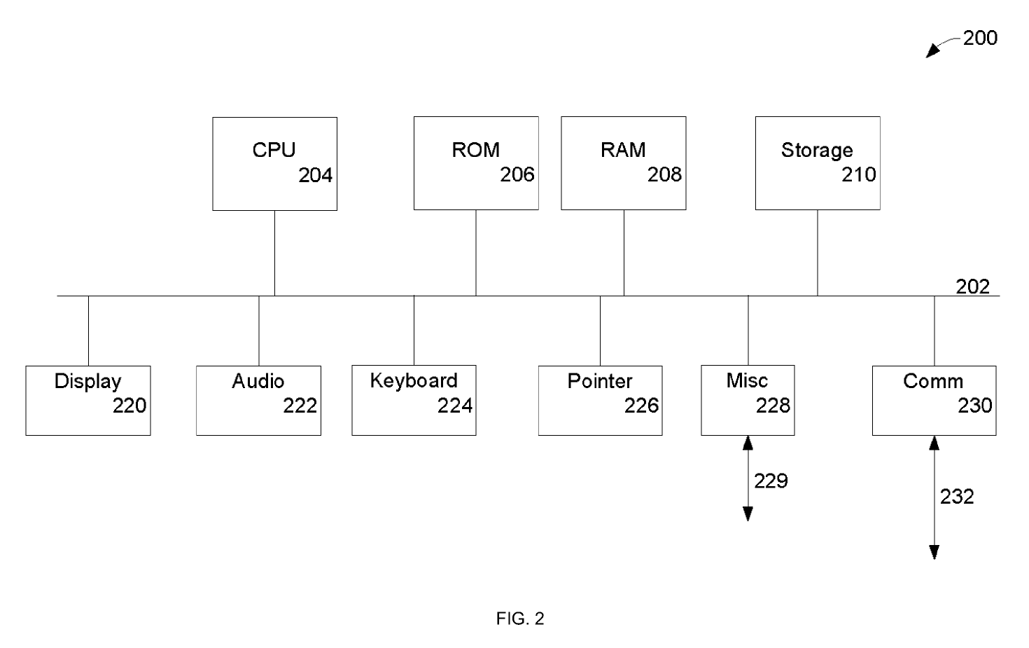

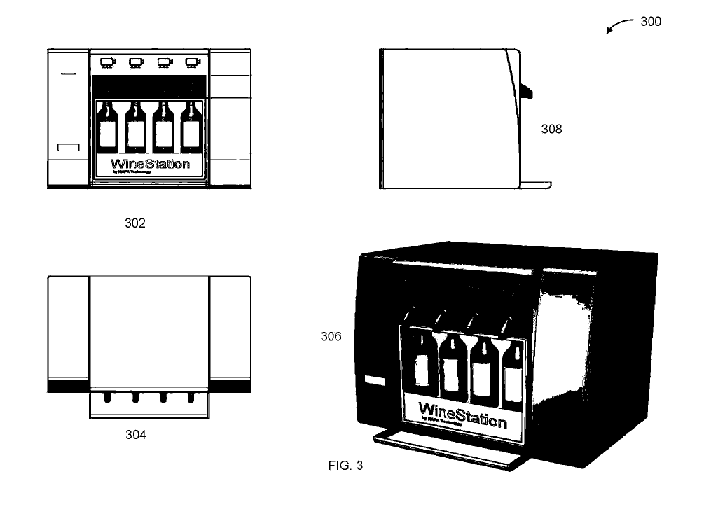

FIG. 2 is a block diagram of a computer system 200 which may be used for implementing some embodiments of the invention, and which may be representative of use in any of the clients and/or servers shown in FIG. 1, as well as, devices, clients, and servers in other Figures. More details are described below.

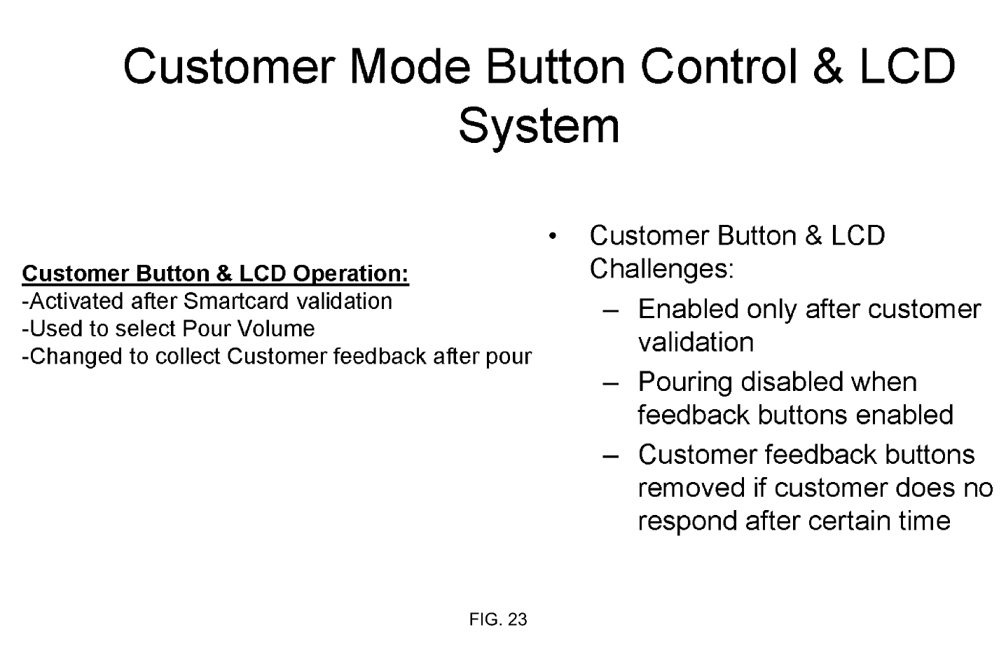

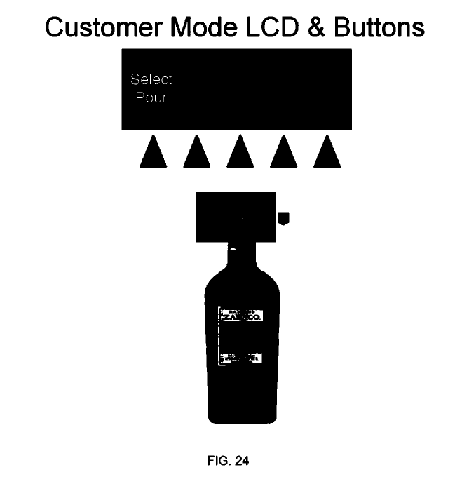

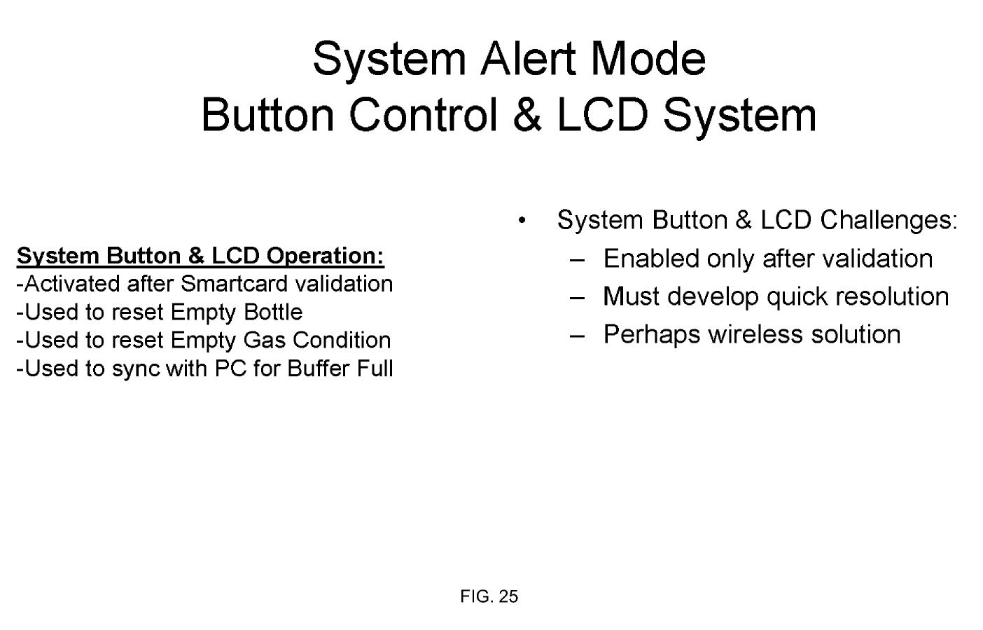

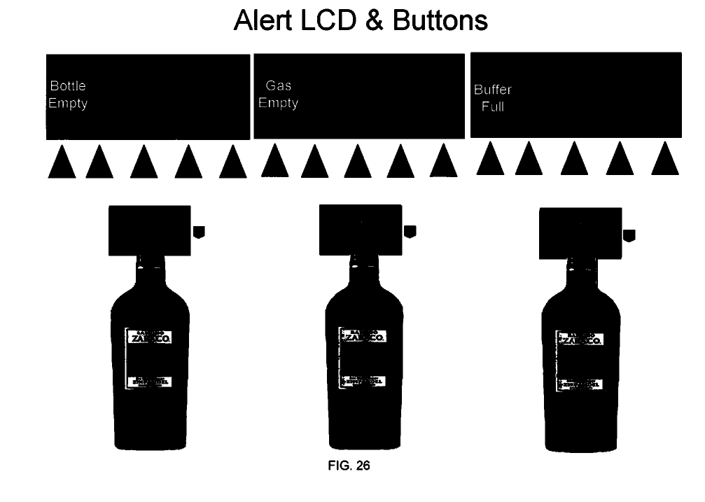

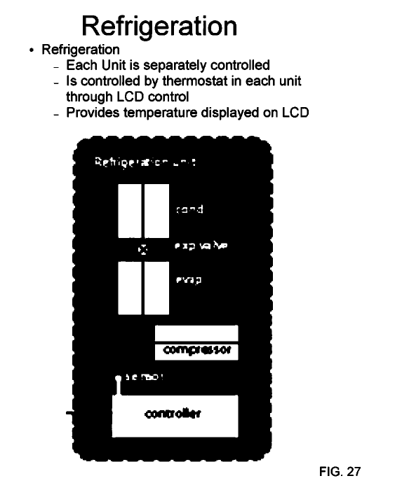

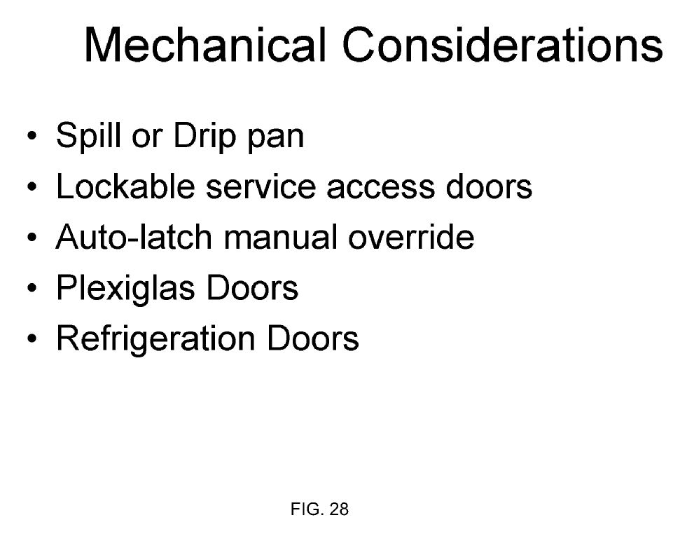

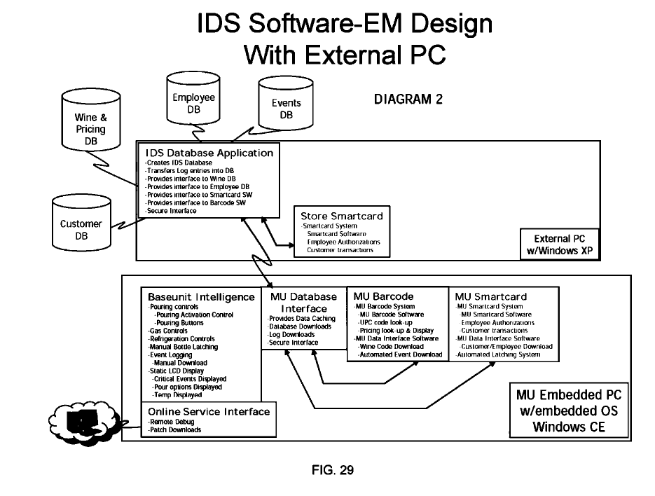

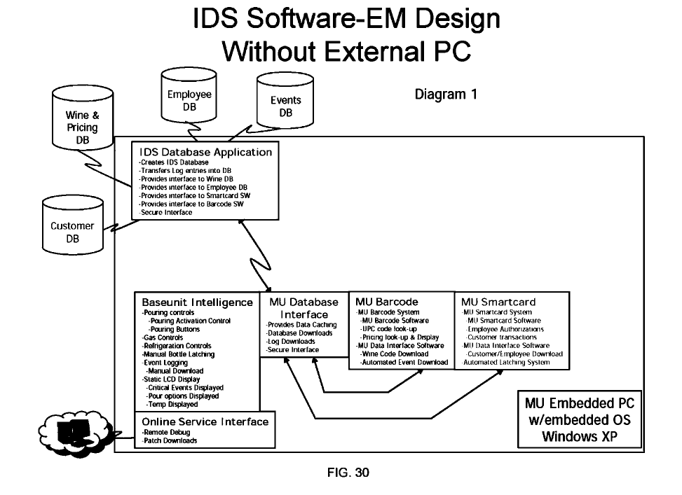

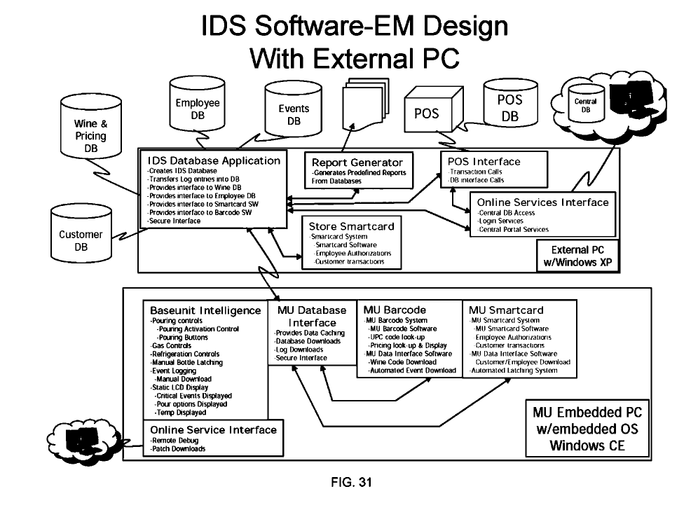

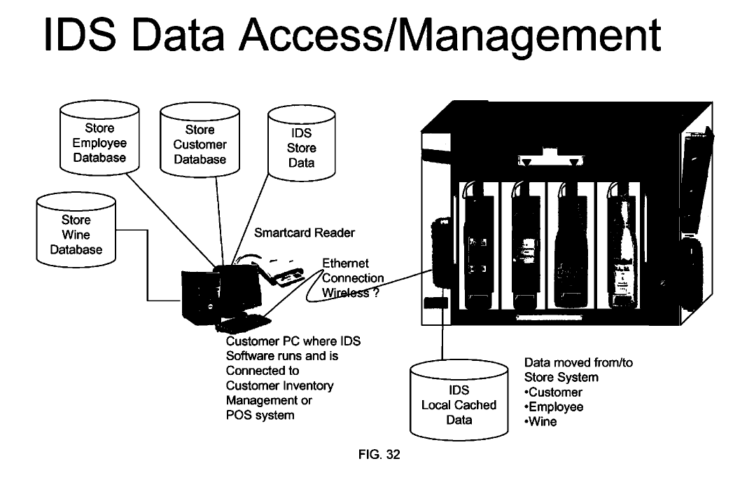

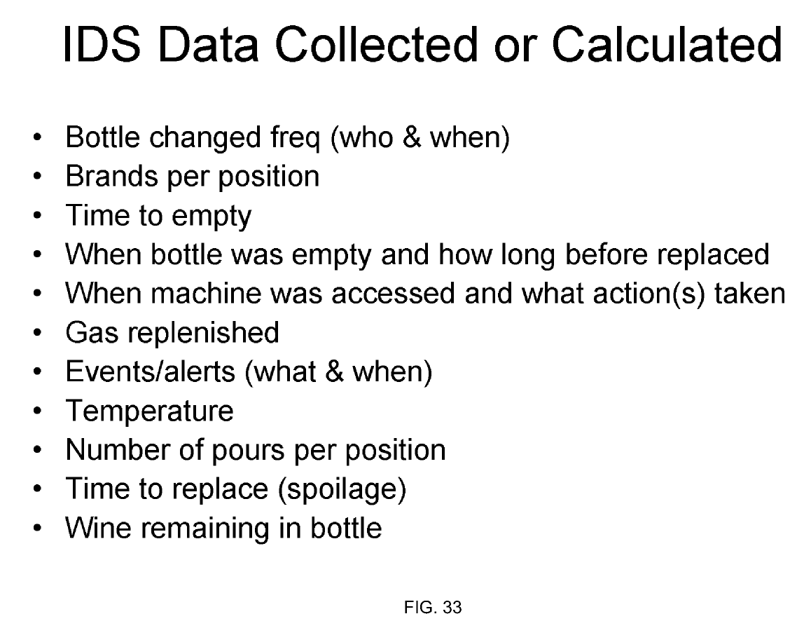

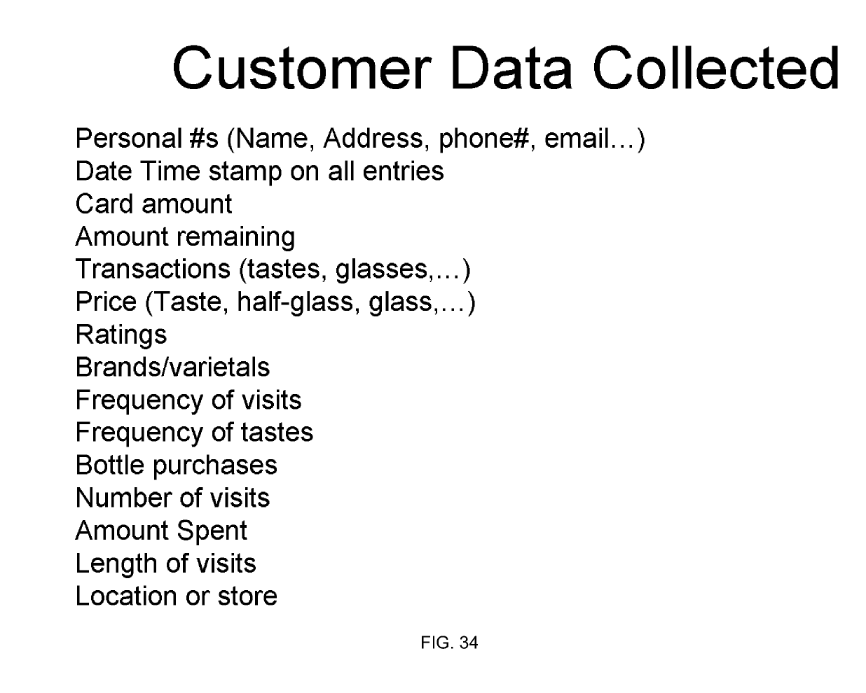

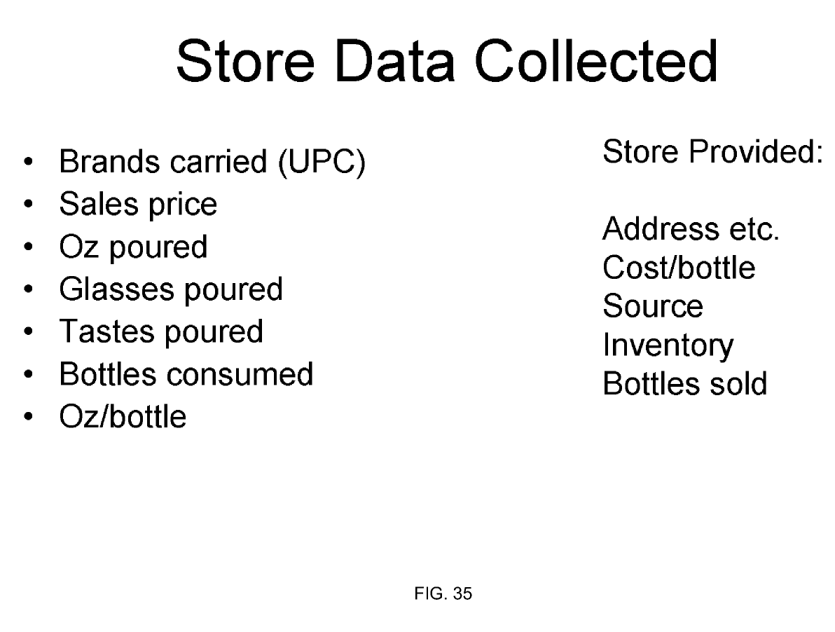

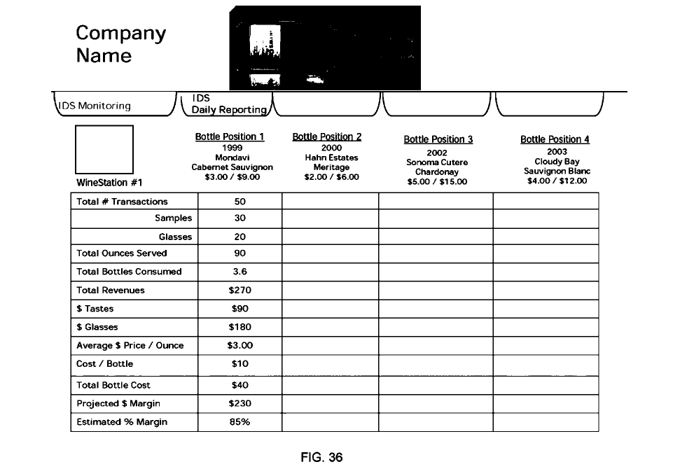

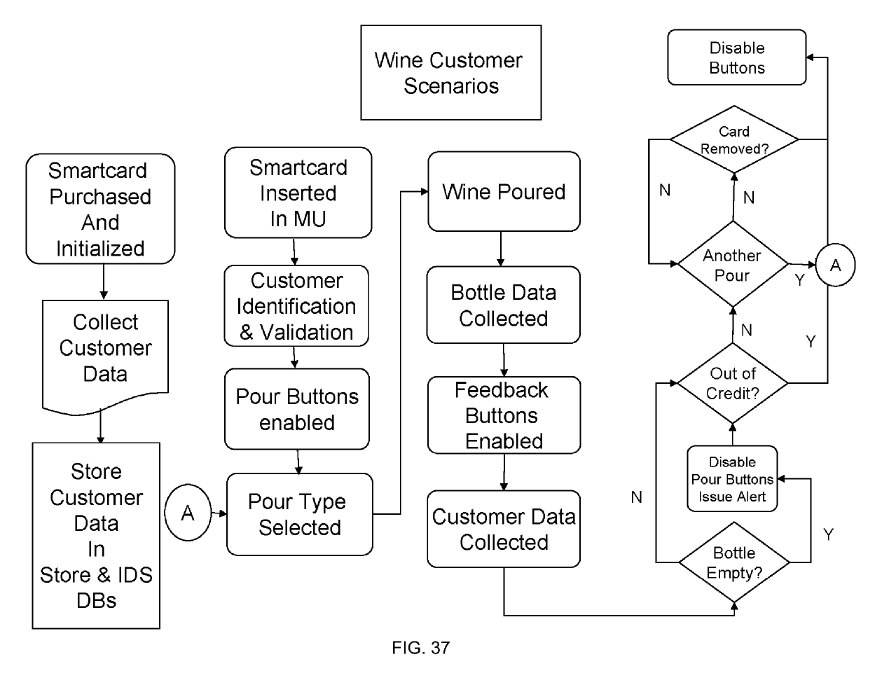

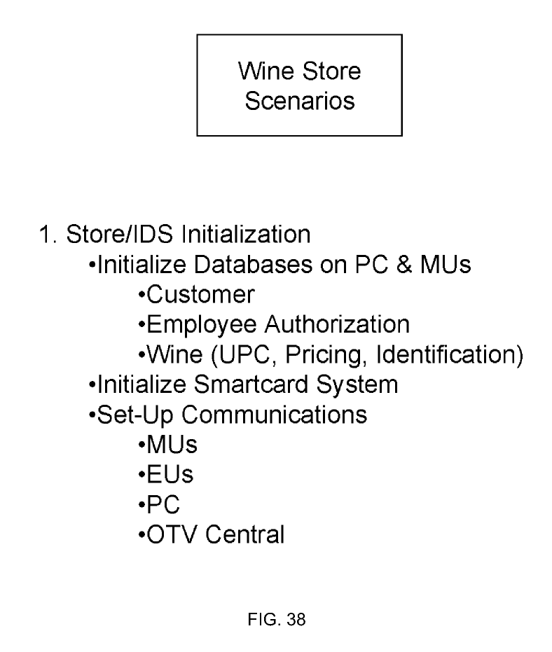

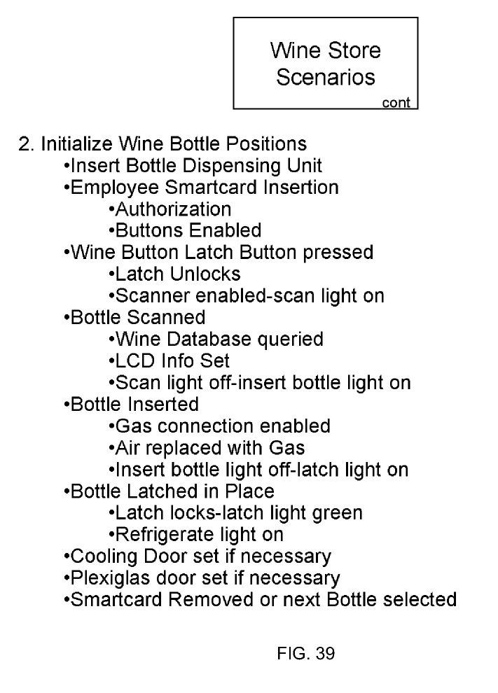

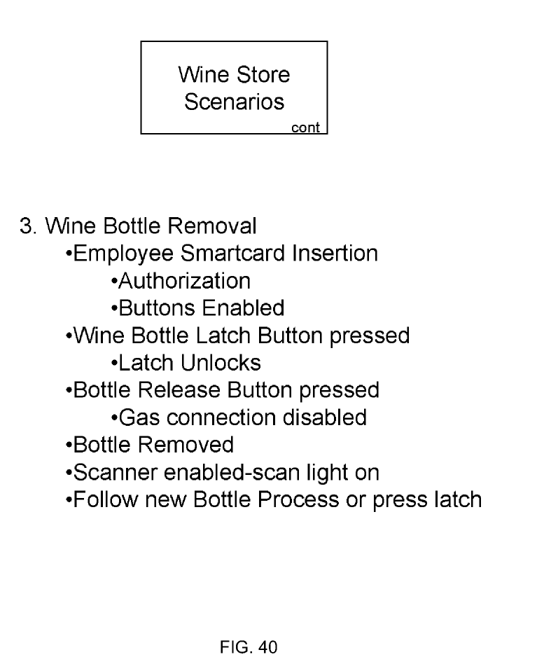

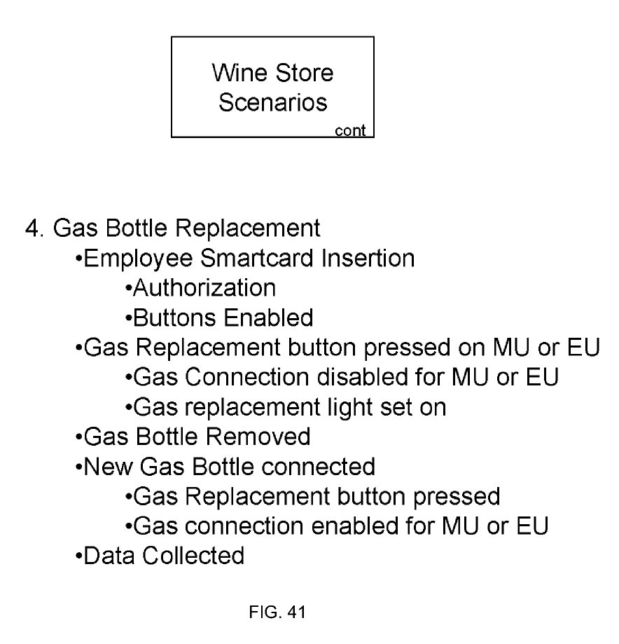

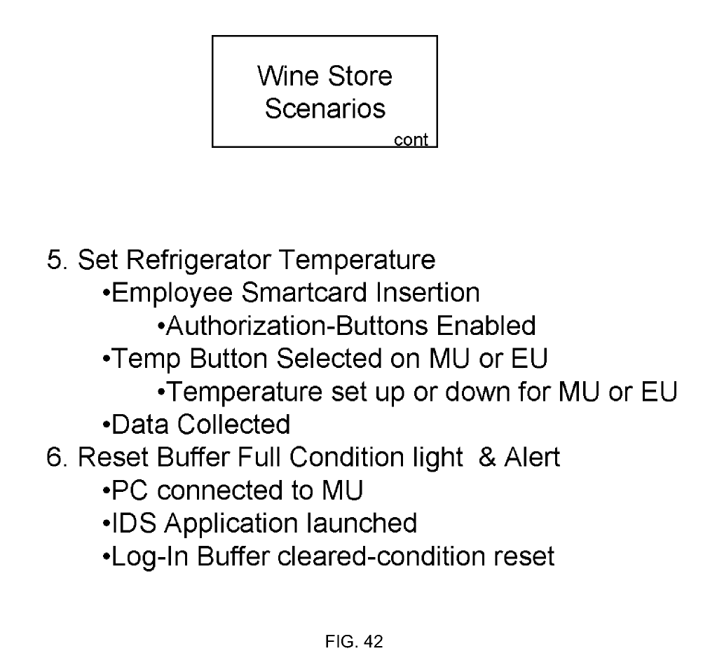

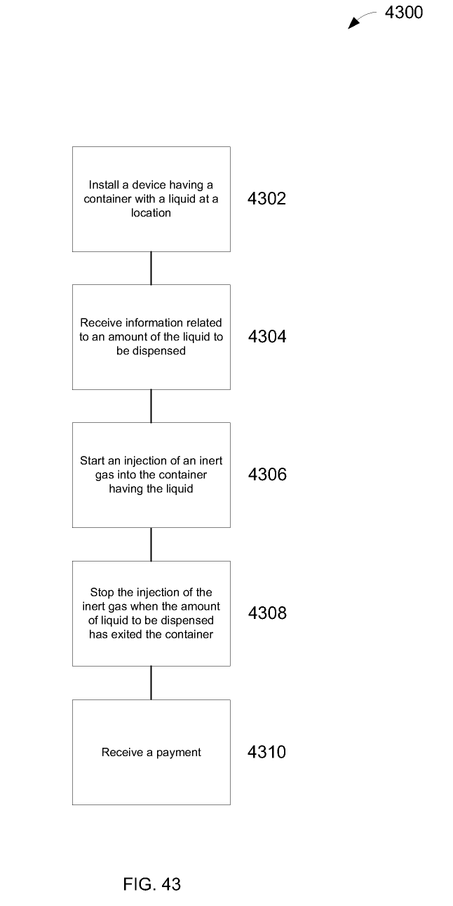

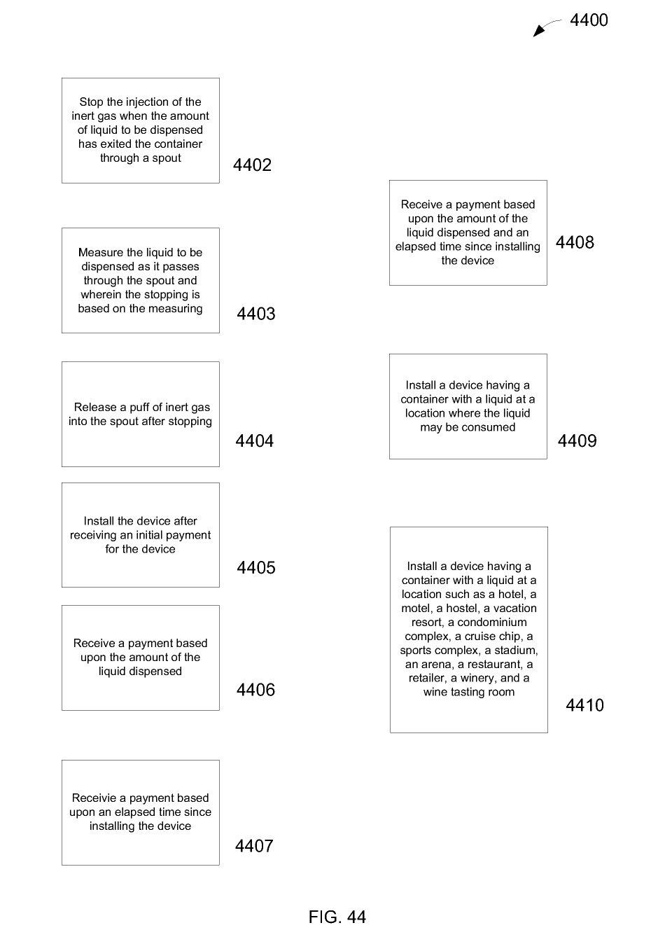

FIGS. 3-42 illustrate various embodiments of the invention.

FIG. 3 illustrates, generally at 300, one embodiment of the invention denoted as WineStation showing several views. A front view 302, a top view 304, a perspective front view 306, and a left side view 308 are shown. In one embodiment the liquid may be wine, however, the invention is not so limited and may be used to dispense any liquid (e.g. seltzer, water, apple juice, orange juice, juices, etc.).

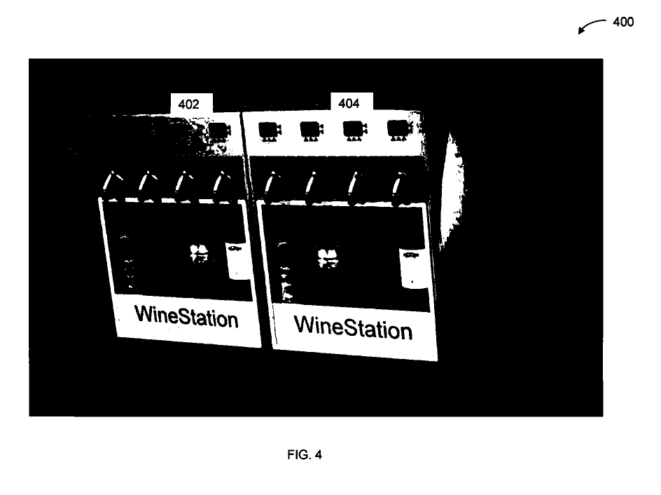

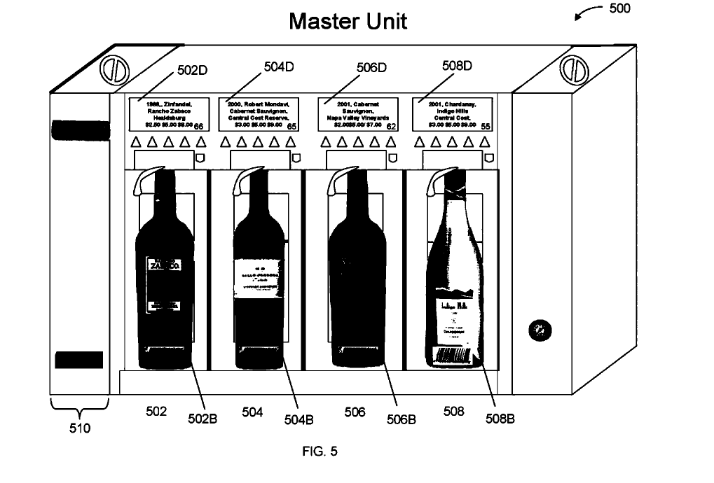

FIG. 4 illustrates, generally at 400, one embodiment of the invention having two stations 402 and 404 connected next to each other. In this way the WineStation may be expanded in capability.

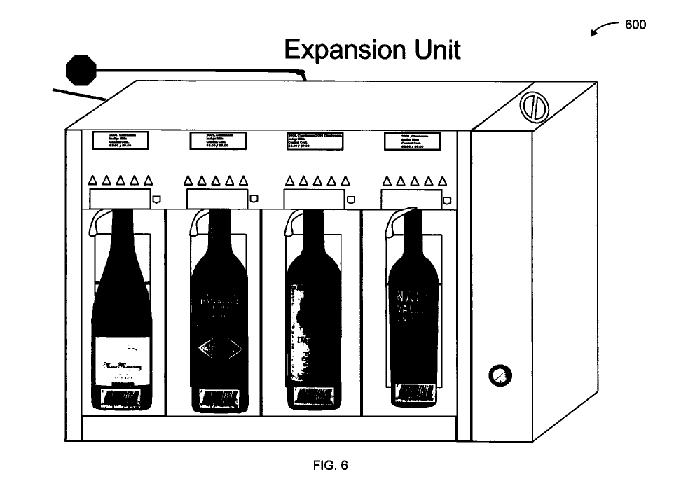

FIG. 5 illustrates, generally at 500, one embodiment of the invention called a master unit. As shown, there are four pouring stalls (502, 504, 506, 508) with bottles (502B, 504B, 506B, 508B) and above them four displays (502D, 504D, 506D, 508D) respectively. On the left side is a unit 510 capable of accepting payments (such as, but not limited to, credit cards, debit cards, smart cards, cash, etc.).

FIG. 6 illustrates, generally at 600, one embodiment of the invention showing an expansion unit.

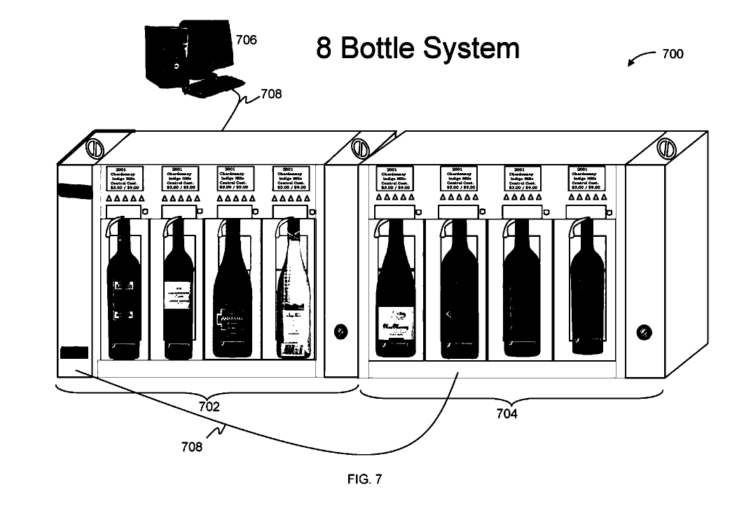

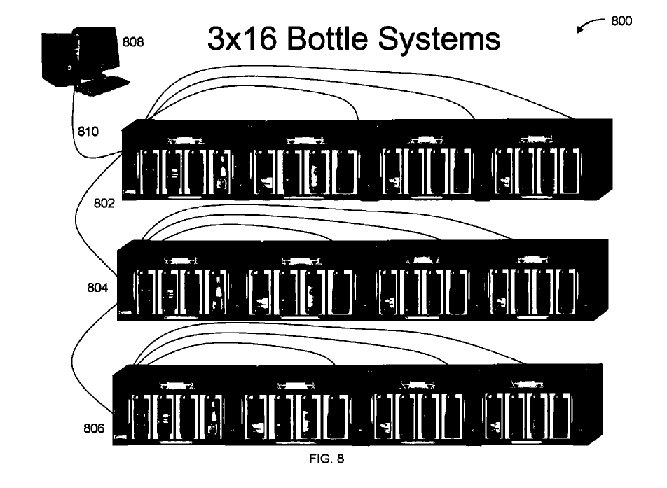

FIG. 7 illustrates, generally at 700, one embodiment of the invention showing an eight bottle system composed of a four unit master 702 coupled to a four unit expansion unit 704. More units may be combined to form, for example, two eight bottle systems, a sixteen bottle system, or any N (integer) bottle system. Also shown is a computer system 706 in communication via 708 with the eight bottle system.

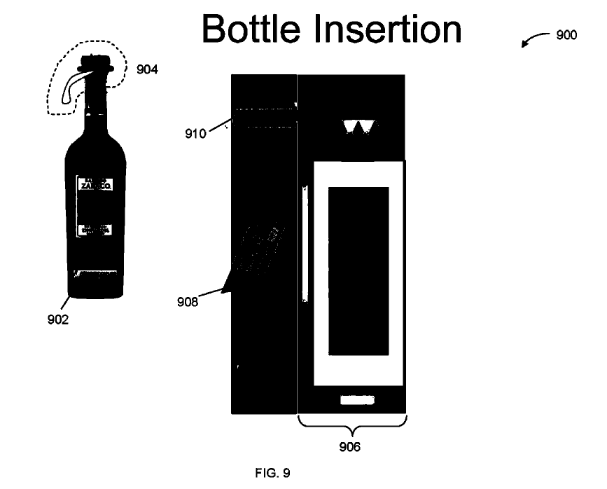

FIG. 8 illustrates, generally at 800, one embodiment of the invention showing a 3×16 bottle system. (3× being 802, 804, 806 with each 1× having 4 stations of 4 bottles (16 total) each.) Also shown is a computer system 808 in communication via 810 with the 3×16 bottle system.

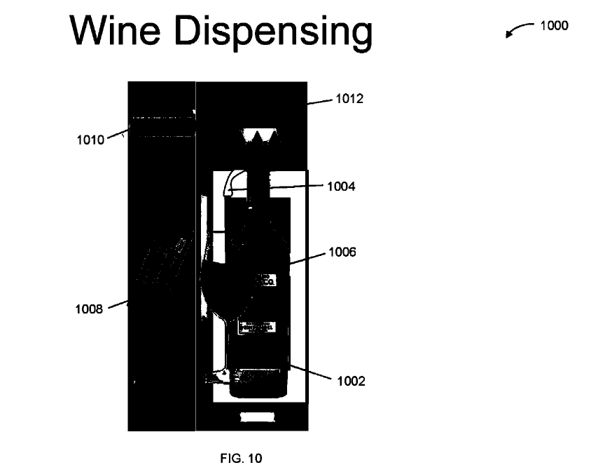

FIG. 9 illustrates, generally at 900, one embodiment of the invention showing bottle insertion. Shown is a bottle 902, with a pouring spout attached 904, a single station for illustration of insertion 906, and a smart card 908, that is inserted at 910 to allow insertion of the bottle by an authorized person.

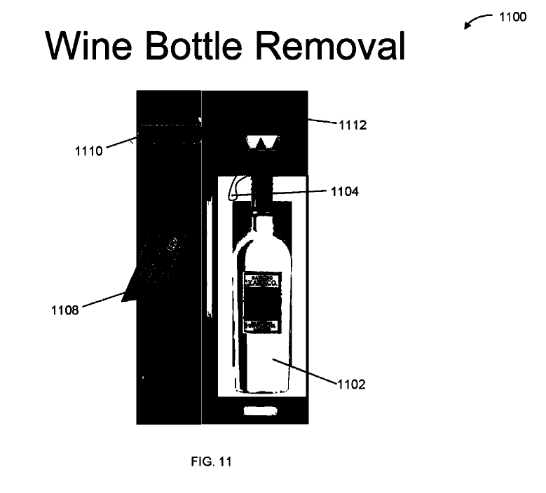

FIG. 10 illustrates, generally at 1000, one embodiment of the invention showing liquid dispensing, in this particular case the liquid is a wine. At 1002 is the bottle, at 1004 the pouring spout, at 1006 the wine glass, at 1008 a smart card, 1010 a smart card slot, and at 1012 information about the contents of the bottle 1002, such as, but not limited to price per pour, vintage, age, name of liquid, vineyard, year, etc.

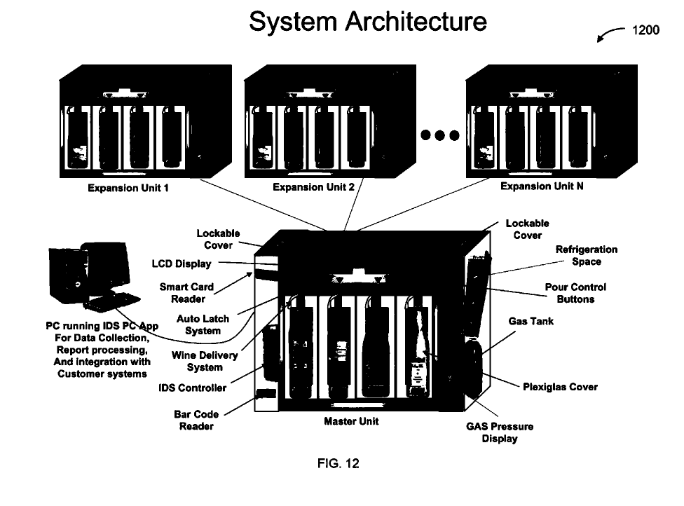

FIG. 11 illustrates, generally at 1100, one embodiment of the invention showing bottle removal. At 1102 is the bottle, at 1104 the pouring spout, at 1108 a smart card, 1110 a smart card slot, and at 1112 information about the contents of the bottle 1102. The smartcard 1108 allows only those authorized to remove a bottle. At 1112 information about the history of the bottle 1102, such as, but not limited to number of pours, time installed, temperature range experienced, total revenue generated, time period of most pours, etc.

FIG. 12 illustrates, generally at 1200, one embodiment of the invention showing a system architecture.

In one embodiment the present invention may be an intelligent dispensing system. Such a system may have features, such as, but not limited to: a Pour Control System—Automated and adjustable Wine Pouring using an Inert Gas; Wine Preservation System—Manages and automates N2 or Ar distribution; Disposable or Washable wine delivery system—Sterile tubing & stopper—Creates vacuum prior to gas injection—Only part that makes contact with Wine; a Smartcard Access & Control System—Provides functional controls & validates customer & operator access—Customer Feedback tracking; Wine Identification System—Provides Wine Bottle Barcode identification against Store or central UPC database; Auto-latching Wine Bottle Security System—Provides control over wine bottle insertion and removal; Attention Required Alert System—Detects Bottle empty condition, gas empty condition, temperature alert, system attention required; Data Collection Manager—IDS Customer Database-tracks all customer info—IDS Store Database-tracks all employee & location related info—IDS System Database-tracks all events and system interactions; Master Unit Communications Manager—Detects, manages, and aggregates data across multiple Master Units—Provides Store PC and IDS central system access and synchronization; IDS Application-Runs on Customer PC—Provides synchronization with IDS Master Units—Provides Store Reporting functions—Provides Interface to supported POS systems—Provides access to Central IDS system our Internet, etc.

In one embodiment of the invention a master unit may have an embedded controller and/or microprocessor for controlling the following features and functions:
Controls Wine Dispensing
   Smartcard Processing
   Pour Buttons
   Controls Latches
   Gas Control
Controls Wine Bottle Functions
   Insertion Process
      Authorization
      Barcode Info
      LCD and Button displays & functions
   Removal Process
      Authorization
Collects All Actions & Alerts
Stores all data in local Database in Non-volatile Storage
Controls Scanning Function
Controls Smartcard Functions
Identifies, connects, and controls EUs attached (Gas bottles & refrigeration)
Connects and communicates to other MUs and passes data through as required
Connects and communicates to IDS PC App
Power distribution to components and connected EUs

In one embodiment of the invention an expansion unit may have many of the features of a master unit. For example, an LCD Display, LCD Controls, Bottle Insertion & Seal Function, Pour Control Function, Independent Gas Tank, and Refrigeration. The expansion unit may also be slaved or in communication with the Master Unit having data passed through communication links.

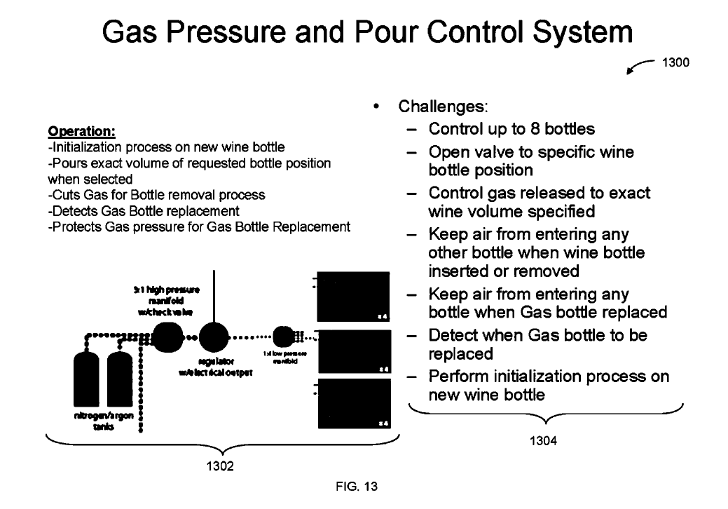

FIG. 13 illustrates, generally at 1300, one embodiment of the invention showing a gas pressure and pour control system 1302 as well as its capabilities 1304.

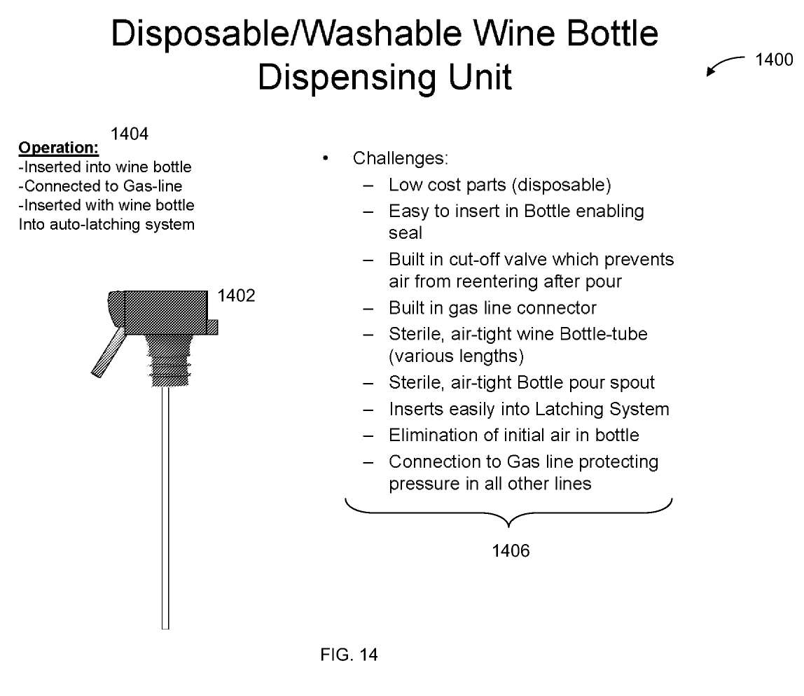

FIG. 14 illustrates, generally at 1400, one embodiment of the invention showing a dispensing head also called a dispensing unit and pouring head 1402, its operation 1404, and capabilities 1406.

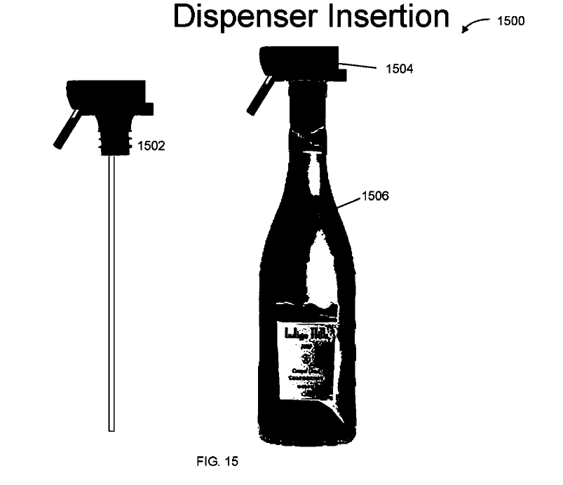

FIG. 15 illustrates, generally at 1500, one embodiment of the invention showing a dispensing head 1502 and after being inserted 1504 into a bottle 1506.

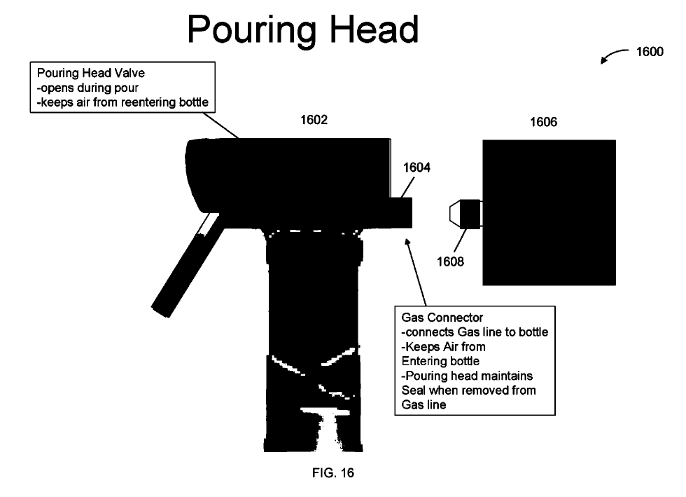

FIG. 16 illustrates, generally at 1600, one embodiment of the invention showing more details of a pouring head 1602, showing a gas connector 1604 which may be connected to a gas source 1606 through a connection 1608.

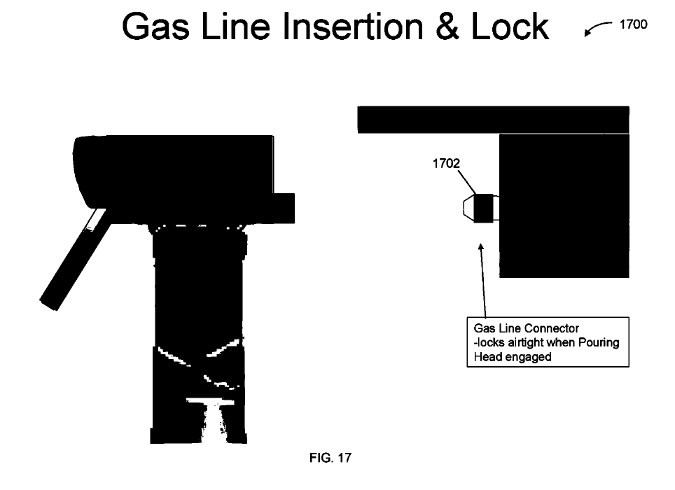

FIG. 17 illustrates, generally at 1700, one embodiment of the invention showing more details of a pouring head gas line 1702 insertion and lock.

In one embodiment of the invention, an auto latching system for the pouring head insures a proper seal with the bottle, can secure the bottle, and may require a smartcard authorization to unlock the bottle. This feature may be on a bottle by bottle basis with, for example, bottled water not having any locks, whereas a bottle of 1937 Glenfiddich under extreme lock control.

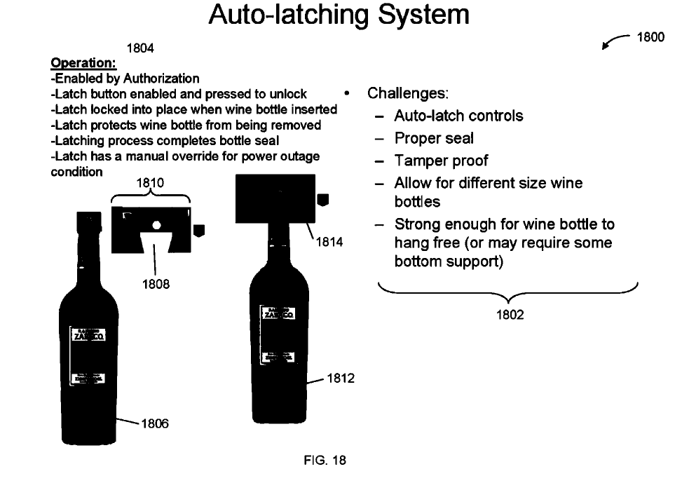

FIG. 18 illustrates, generally at 1800, one embodiment of the invention showing more details of an auto-latching system showing capabilities 1802, operation 1804, a bottle 1806 ready to be inserted into a docking position 1808 of a bay 1810, and at 1812 the bottle inserted and the latch 1814 in place securing the bottle 1812 from removal.

In one embodiment of the invention, a barcode system may be used to among other things, automate liquid information entry (for example, bottled water v. whiskey, wine, etc.), access prices for the bottles from a database, display relevant information on the LCD above the bottle, interface with a database (such as a wine database to obtain ratings, suggested accompaniments, etc.

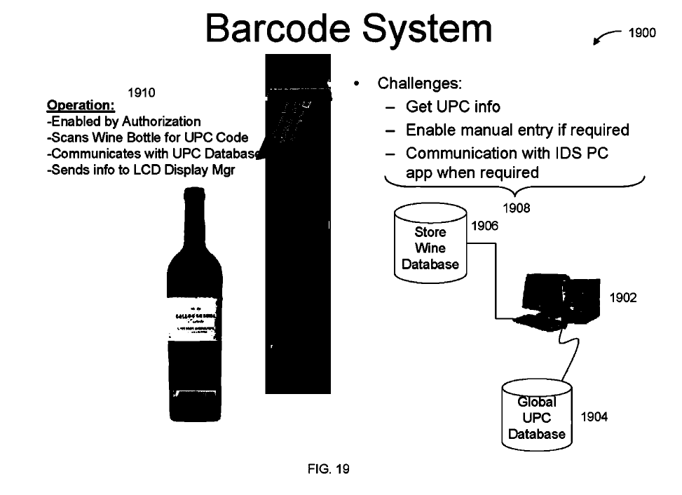

FIG. 19 illustrates, generally at 1900, one embodiment of the invention showing more details of a barcode system, with a computer system 1902, in communication with a global UPC database 1904 and a store wine database 1906. The system has capabilities 1908, and operation 1910.

In one embodiment of the invention, a smartcard or equivalent type system (RFID, etc.) may provide security for the latching system, provides security for LCD functions, provides security for system functions, unlocks the pouring system, tracks customer debit or credit, interfaces with customer info database, etc. Different cards may be given to different customers, etc.

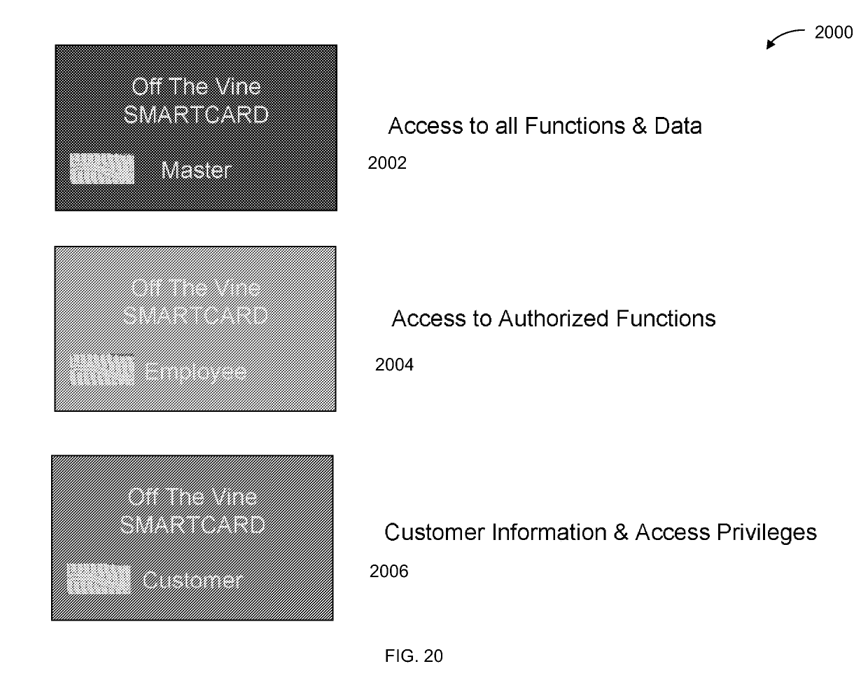

FIG. 20 illustrates, generally at 2000, one embodiment of the invention showing different types of cards granting different access rights (2002, 2004, 2006).

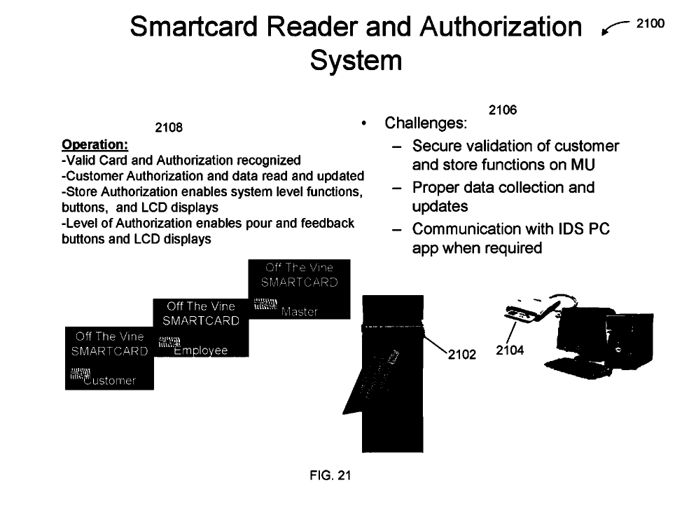

FIG. 21 illustrates, generally at 2100, one embodiment of the invention showing a Smartcard Reader 2102 on the liquid dispensing system and 2104 on the Authorization System. The capabilities are listed at 2106 and operation at 2108.

In one embodiment of the present invention, LCD panels with display and input are located above each bottle. The LCD Display may show such information as Price per pour, Wine Info, Compartment Temperature, Customer Ratings, Alert Conditions, etc.

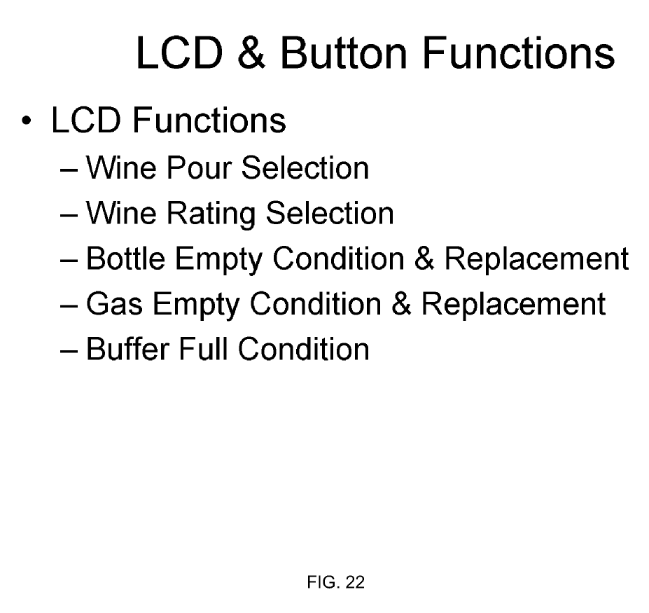

FIGS. 22-42, illustrate various embodiments of the present invention.

FIG. 43 illustrates, generally at 4300, one embodiment of the invention showing installing a device having a container with a liquid at a location 4302, receiving information related to an amount of the liquid to be dispensed 4304, starting an injection of an inert gas into the container having the liquid 4306, stopping the injection of the inert gas when the amount of the liquid to be dispensed has exited the container 4308, and receiving a payment 4310.

FIG. 44 illustrates, generally at 4400, various embodiment of the invention, stopping the injection of the inert gas when the amount of liquid to be dispensed has exited the container through a spout 4402, measuring the liquid to be dispensed as it passes through the spout and wherein the stopping is based on the measuring 4403, releasing a puff of inert gas into the spout after stopping 4404, installing the device after receiving an initial payment for the device 4405, receiving a payment based upon the amount of the liquid dispensed 4406, receiving a payment based upon an elapsed time since installing the device 4407, receiving a payment based upon the amount of the liquid dispensed and an elapsed time since installing the device 4408, installing a device having a container with a liquid at a location where the liquid may be consumed 4409, and installing a device having a container with a liquid at a location such as a hotel, a motel, a hostel, a vacation resort, a condominium complex, a cruise chip, a sports complex, a stadium, an arena, a restaurant, a retailer, a winery, and a wine tasting room 4410.

In one embodiment the present invention may be an intelligent dispensing system having a pay per use model for serving liquid in glasses, cups, etc. for consumption. That is, in the pay per use model, a vendor, such as the supplier of the intelligent dispensing system may install a system at a location and may be compensated based on the usage of the system, for example each time the system is used, there is a payment that eventually goes to the vendor. One of skill in the art will appreciate that many variations of pay per use are possible, for example, the pay per use may be different depending upon whether the establishment has made any payment for the system or if the vendor is supplying the system for free. For example, if dispensing wine, the establishment may prefer to pay for the system and then pay a lower pay per use rather than getting the machine for little or no cost and then paying a higher pay per use. Additionally the pay per use model may be affected depending upon whether the vendor or the establishment provides the liquids to be dispensed. For example, if dispensing wine, the establishment may prefer to reload the system with wine rather than having to contact the system vendor.

In one embodiment the present invention may be an intelligent dispensing system having a revenue sharing model for serving liquid in glasses, cups, etc. for consumption. That is, in the revenue sharing model, a vendor, such as the supplier of the intelligent dispensing system may install a system at a location of an establishment, for example a restaurant, and the vendor be compensated based on the revenue generated by usage of the system at the restaurant, for example each time the system is used, there is a revenue generated and that is shared between the vendor and the restaurant. One of skill in the art will appreciate that many variations of revenue sharing are possible, for example, the sharing may be different depending upon whether the vendor or the establishment provides the liquids to be dispensed. For example, if dispensing wine, the establishment may prefer to reload the system with wine rather than having to contact the system vendor. Additionally the revenue sharing may be different depending upon whether the establishment has made any payment for the system or if the vendor is supplying the system for free. For example, if dispensing wine, the establishment may prefer to pay for the system and then pay a lower revenue share rather than getting the machine for little or no cost and then paying a higher revenue share.

In one embodiment the present invention may be an intelligent dispensing system having a revenue sharing model for serving liquid in glasses, cups, etc. for consumption based on a pay per use model for serving liquid in glasses, cups, etc. for consumption.

In one embodiment the present invention may provide a way for a hotel, a vacation resort, a condominium complex, a cruise ship, a stadium, an arena, a restaurant, retailers, etc. a method to dispense wine and other liquids at predefined volumes without purchasing or leasing the required equipment. The customers (Hotel, Vacation Resort, Condominium Complex, Cruise Ship, Stadium, Arena, Restaurant, Retailers) could pay a percentage of what has been sold to their patrons to an equipment provider.

In various embodiments the present invention may be used thusly:
1. Identify potential customer.(Customer may be a Hotel, Vacation Resort, Condominium Complex, Cruise Ship, Stadium, Arena, Restaurant, Retailer, etc.)
2. Secure the rights to install units for minimal to zero cost to customer for a portion of the proceeds.
3. The customer can manually or the equipment can automatically track what has been served to the users, patrons, etc.
4. Based on an agreed upon timeframe the customer pays the equipment provider a portion of the proceeds.
5. The Customer may elect to provide the consumable liquid themselves.
6. The Customer may elect to have the equipment provider provide the consumable liquid.
7. The Customer may be given an opportunity to pay as low as $0 (Zero dollars) to have the equipment.
8. The Customer may elect make an initial payment to the equipment provider in order to secure a lower pay per use percentage.

In one embodiment the present invention may be used in a pay per use/revenue share method for controlled, automated, and intelligent wine, beer, spirit, water, and liquid dispensing into a glass, a cup, a mug, etc. for use in hotel, a vacation resort, a pub, a bar, a condominium complex, a housing development, a waiting area, a cruise ship, a stadium, an arena, a restaurant, a retail environments, a mall, etc.

In one embodiment the present invention may have features, such as, but not limited to: a Pour Control System—Automated and adjustable Wine Pouring using an Inert Gas; Wine Preservation System—Manages and automates N2 or Ar distribution; Disposable or Washable wine delivery system—Sterile tubing & stopper—Creates vacuum prior to gas injection—Only part that makes contact with Wine; a Smartcard Access & Control System—Provides functional controls & validates customer & operator access—Customer Feedback tracking; Wine Identification System—Provides Wine Bottle Barcode identification against Store or central UPC database; Auto-latching Wine Bottle Security System—Provides control over wine bottle insertion and removal; Attention Required Alert System—Detects Bottle empty condition, gas empty condition, temperature alert, system attention required; Data Collection Manager- IDS Customer Database-tracks all customer info—IDS Store Database-tracks all employee & location related info—IDS System Database-tracks all events and system interactions; Master Unit Communications Manager—Detects, manages, and aggregates data across multiple Master Units—Provides Store PC and IDS central system access and synchronization; IDS Application-Runs on Customer PC—Provides synchronization with IDS Master Units—Provides Store Reporting functions—Provides Interface to supported POS systems—Provides access to Central IDS system our Internet, etc.

In one embodiment of the invention the following features are available basic wine preservation, refrigeration, automated wine preservation, automated pour control wine transaction tracking, customer smartcard control, employee smart card control, unit management, LCD wine identification display, merchandising manager, product/brand management, site location manager, customer marketing manager, inventory manager, distributor/wholesaler manager, disposable delivery, auto-latch security, UPC/barcode database management, wine rating management.

In one embodiment, the present invention provides a way that wine and other liquids can be dispensed at predefined volumes using a preserving gas. It also provides a system for capturing, presenting, managing, and reporting data and information related to dispensing.

In one embodiment of the invention a dispensing head is used to dispense the liquid. In various embodiments of the dispensing head, it may be designed to have the following features and allow the following operation. The dispensing head in one embodiment is the only part that makes contact with the wine or liquid. It is designed as being disposable and hence eliminates the need for cleaning the dispensing unit. The dispensing head once inserted into the Dispensing Unit enables the purging of the initial air that is present in a bottle when it is first opened, by replacing this air with an inert gas such as Nitrogen or Argon. Once this purging is complete the dispensing head is sealed and prevents air from reentering the bottle. The bottle can then be served in predefined measured volumes by pressing a button on the dispensing unit. The button signals the unit to pour the desired volume by starting the flow of the inert gas into the bottle and displacing the desired liquid into a waiting glass at the dispensing head spout. The dispensing head after it has poured the desired volume into the glass, performs a puff function using the inert gas to clear any liquid that remains in the dispensing head spout into the glass. After the initial purging of the initial air in the bottle the bottle can also be removed at any time from the dispensing unit and be stored for later use due to the dispensing head's ability to prevent air from reentering the bottle, hence preserving the liquid for long periods. The dispensing head also has a built in detection mechanism to ensure that the proper volume is being served. One such way to detect the volume is by detecting the liquid in the dispensing head spout by detecting a current through the liquid as it is pouring. The dispensing head also has a built in mechanism that detects that it is properly positioned in the dispensing head bay. One way this may be accomplished is through electrically detecting the proper positioning of the head in the unit. The dispensing head also has a special mechanism that aligns with the inert gas valve that ensures that it is properly engaged into the dispensing head unit. The dispensing head also has a head locking mechanism built into the rotor and cap portions of the head that prevent a person from accidentally opening the dispensing head and exposing it to the air when the bottle is removed from the dispensing unit. The reason that someone would want to remove a full or partially opened bottle from the dispensing unit is for pre-staging purposes or for the flexibility of changing to offer other wine or liquid dispensing before the entire bottle has been entirely been served.

In one embodiment of the invention an actuation and automated dispensing bay is used. In various embodiments of the actuation and automated dispensing bay, it may be designed to have the following features and allow the following operation. The actuation and automated dispensing bay design of the dispensing system provides a number of features. It provides an unlocking function for the dispensing head's locking mechanism to enable the free rotation of the dispensing head rotor. It provides the detection function for the dispensing head's Alignment mechanism. The Gas Stem provides the gas valve mechanism that engages with the dispensing heads ensuring a proper seal and prevents gas from leaking. The actuation system detects the proper position of the dispensing head's rotor for the pour, puff, and purge functions with the use of sensor (such as optical). The actuation system uses the sensor and a backup power source (such as a capacitor) to ensure that the dispensing head is closed in the event of a power failure during a pour operation. The automated dispensing bay provides for a quick release mechanism for the dispensing head when the dispensing head bay is opened for bottle removal or insertion. This allows for the protection of the gas from leaking out of the unit.

In one embodiment of the invention electrical and controller functions are used. In various embodiments of the electrical and controller functions, they may be designed to have the following features and allow the following operation. A Gas Transducer and low pressure switch is used to detect inert gas levels and pressures in the gas system and wine bottles. The controller detects gas leakage in the system. It also detects the gas required to dispense the liquid in the bottle and can also detect the amount of liquid volume in the bottle and assures that the volume left in the bottle is properly calculated for dispensing to customers. Door Solenoids are used to automate the opening of the Thermal Door as well as the Gas Door. The opening of the doors is initiated by the insertion of the proper authorized smartcard into the smartcard reader contained in the system enclosure. LCDs are used to display the wine or liquid information for the bottle inserted in a given bay position. The information is pulled from a locally managed SQL database after the UPC code is scanned through the barcode scanner that is mounted in the system enclosure. Control Buttons mounted around the LCDs provide controls for both the customer pouring a liquid into a glass as well as the servicing functions for the dispensing unit. The customer initiates the pouring functions after inserting a valid smartcard. The functions include the selection of the desired volume of the wine or liquid. The servicing functions are only available to authorized smartcards and include the wine or liquid bottle insertion or removal, the inert gas bottle insertion or removal, temperature setting for the thermal control, as well as the resetting of system functions. The Controller collects and logs every event and action initiated by the customer, the operator, or the system. The Microprocessor of the system interfaces with the Controller subsystem and collects all events and actions of the dispensing system into an SQL database for further reporting and processing. The Controller controls multiple dispensing heads subsystems, controls internal or external inert gas systems, interfaces with barcode scanner, smartcard reader, Thermal Electronic Coupling subsystem, and microprocessors or PCs. Controllers are designed for modularity and multiple controllers can be chained together and can share one microprocessor or PC, one smartcard reader, and one barcode scanner, for central data collection and management. There is no theoretical limit to the number of controllers that may be chained together.

In one embodiment of the invention smartcards, barcodes, and software are used. In various embodiments of the smartcards, barcodes, and software, they may be designed to have the following features and allow the following operation. Smartcard readers using password protected memory cards are used for activating customer pouring functions. Cards can be defined as either credit or debit with limits defined. The software which supports the smartcard functions ensures the proper charging for the different quantities of wine or liquid being purchased. Barcode reader scans the UPC code from the wine or liquid bottle and passes this information to the Application which is running on the Microprocessor or PC. The Software provides the following major functions: a. the interfacing with the Controller providing for data collection and logging for further report generation and data analysis. b. the database definition and management for the wine database which contains both the UPC codes and mapping as well as pricing information from which the wine or liquid pricing is pulled for display on dispensing unit LCDs, the customer database which contains customer account information including customer history, the store or establishment information regarding authorized personnel from which authorized smartcards are validated, the system database which contains all system installation parameters, system events and logs, and customer system preferences. c. the systems management and communications between the embedded microprocessor or PC and the external customer PC to run and manage the installation.

In one embodiment of the present invention provides for an Automated and Intelligent Liquid Dispensing Head and System. The system provides a way that wine and other liquids can be dispensed at predefined volumes using a preserving gas. It also provides a system for capturing, presenting, managing, and reporting data and information related to dispensing.

Thus a method and apparatus for pay per use and revenue sharing for liquid dispensing have been described.

FIG. 1 illustrates a network environment 100 in which the techniques described may be applied. The network environment 100 has a network 102 that connects S servers 104-1 through 104-S, and C clients 108-1 through 108-C. More details are described below.

FIG. 2 illustrates a computer system 200 in block diagram form, which may be representative of any of the clients and/or servers shown in FIG. 1, as well as, devices, clients, and servers in other Figures. More details are described below.

Referring back to FIG. 1, FIG. 1 illustrates a network environment 100 in which the techniques described may be applied. The network environment 100 has a network 102 that connects S servers 104-1 through 104-S, and C clients 108-1 through 108-C. As shown, several computer systems in the form of S servers 104-1 through 104-S and C clients 108-1 through 108-C are connected to each other via a network 102, which may be, for example, a corporate based network. Note that alternatively the network 102 might be or include one or more of: the Internet, a Local Area Network (LAN), Wide Area Network (WAN), satellite link, fiber network, cable network, or a combination of these and/or others. The servers may represent, for example, disk storage systems alone or storage and computing resources. Likewise, the clients may have computing, storage, and viewing capabilities. The method and apparatus described herein may be applied to essentially any type of visual communicating means or device whether local or remote, such as a LAN, a WAN, a system bus, etc. Thus, the invention may find application at both the S servers 104-1 through 104-S, and C clients 108-1 through 108-C.

Referring back to FIG. 2, FIG. 2 illustrates a computer system 200 in block diagram form, which may be representative of any of the clients and/or servers shown in FIG. 1. The block diagram is a high level conceptual representation and may be implemented in a variety of ways and by various architectures. Bus system 202 interconnects a Central Processing Unit (CPU) 204, Read Only Memory (ROM) 206, Random Access Memory (RAM) 208, storage 210, display 220, audio, 222, keyboard 224, pointer 226, miscellaneous input/output (I/O) devices 228 (for example, embodiments of the present invention), and communications 230. The bus system 202 may be for example, one or more of such buses as a system bus, Peripheral Component Interconnect (PCI), Advanced Graphics Port (AGP), Small Computer System Interface (SCSI), Institute of Electrical and Electronics Engineers (IEEE) standard number 1394 (FireWire), Universal Serial Bus (USB), etc. The CPU 204 may be a single, multiple, or even a distributed computing resource. Storage 210 may be Compact Disc (CD), Digital Versatile Disk (DVD), hard disks (HD), optical disks, tape, flash, memory sticks, video recorders, etc. Display 220 might be, for example, an embodiment of the present invention. Note that depending upon the actual implementation of a computer system, the computer system may include some, all, more, or a rearrangement of components in the block diagram. For example, a thin client might consist of a wireless hand held device that lacks, for example, a traditional keyboard. Thus, many variations on the system of FIG. 2 are possible.

For purposes of discussing and understanding the invention, it is to be understood that various terms are used by those knowledgeable in the art to describe techniques and approaches. Furthermore, in the description, for purposes of explanation, numerous specific details are set forth in order to provide a thorough understanding of the present invention. It will be evident, however, to one of ordinary skill in the art that the present invention may be practiced without these specific details. In some instances, well-known structures and devices are shown in block diagram form, rather than in detail, in order to avoid obscuring the present invention. These embodiments are described in sufficient detail to enable those of ordinary skill in the art to practice the invention, and it is to be understood that other embodiments may be utilized and that logical, mechanical, electrical, and other changes may be made without departing from the scope of the present invention.

Some portions of the description may be presented in terms of algorithms and symbolic representations of operations on, for example, data bits within a computer memory. These algorithmic descriptions and representations are the means used by those of ordinary skill in the data processing arts to most effectively convey the substance of their work to others of ordinary skill in the art. An algorithm is here, and generally, conceived to be a self-consistent sequence of acts leading to a desired result. The acts are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion, it is appreciated that throughout the description, discussions utilizing terms such as “processing” or “computing” or “calculating” or “determining” or “displaying” or the like, can refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

An apparatus for performing the operations herein can implement the present invention. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, hard disks, optical disks, compact disk- read only memories (CD-ROMs), and magnetic-optical disks, read-only memories (ROMs), random access memories (RAMs), electrically programmable read-only memories (EPROM)s, electrically erasable programmable read-only memories (EEPROMs), FLASH memories, magnetic or optical cards, etc., or any type of media suitable for storing electronic instructions either local to the computer or remote to the computer.

The algorithms and displays presented herein are not inherently related to any particular computer or other apparatus. Various general-purpose systems may be used with programs in accordance with the teachings herein, or it may prove convenient to construct more specialized apparatus to perform the required method. For example, any of the methods according to the present invention can be implemented in hard-wired circuitry, by programming a general-purpose processor, or by any combination of hardware and software. One of ordinary skill in the art will immediately appreciate that the invention can be practiced with computer system configurations other than those described, including hand-held devices, multiprocessor systems, microprocessor-based or programmable consumer electronics, digital signal processing (DSP) devices, set top boxes, network PCs, minicomputers, mainframe computers, and the like. The invention can also be practiced in distributed computing environments where tasks are performed by remote processing devices that are linked through a communications network.

The methods of the invention may be implemented using computer software. If written in a programming language conforming to a recognized standard, sequences of instructions designed to implement the methods can be compiled for execution on a variety of hardware platforms and for interface to a variety of operating systems. In addition, the present invention is not described with reference to any particular programming language. It will be appreciated that a variety of programming languages may be used to implement the teachings of the invention as described herein. Furthermore, it is common in the art to speak of software, in one form or another (e.g., program, procedure, application, driver, . . . ), as taking an action or causing a result. Such expressions are merely a shorthand way of saying that execution of the software by a computer causes the processor of the computer to perform an action or produce a result.

It is to be understood that various terms and techniques are used by those knowledgeable in the art to describe communications, protocols, applications, implementations, mechanisms, etc. One such technique is the description of an implementation of a technique in terms of an algorithm or mathematical expression. That is, while the technique may be, for example, implemented as executing code on a computer, the expression of that technique may be more aptly and succinctly conveyed and communicated as a formula, algorithm, or mathematical expression. Thus, one of ordinary skill in the art would recognize a block denoting A+B=C as an additive function whose implementation in hardware and/or software would take two inputs (A and B) and produce a summation output (C). Thus, the use of formula, algorithm, or mathematical expression as descriptions is to be understood as having a physical embodiment in at least hardware and/or software (such as a computer system in which the techniques of the present invention may be practiced as well as implemented as an embodiment).

A machine-readable medium is understood to include any mechanism for storing or transmitting information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals capable of causing excitation of physical matter (e.g. electrons, atoms, etc.) upon reception (e.g., carrier waves, infrared signals, digital signals, etc.); etc.

As used in this description, “one embodiment” or “an embodiment” or similar phrases means that the feature(s) being described are included in at least one embodiment of the invention. References to “one embodiment” in this description do not necessarily refer to the same embodiment; however, neither are such embodiments mutually exclusive. Nor does “one embodiment” imply that there is but a single embodiment of the invention. For example, a feature, structure, act, etc. described in “one embodiment” may also be included in other embodiments. Thus, the invention may include a variety of combinations and/or integrations of the embodiments described herein.

Thus a method and apparatus for pay per use and revenue sharing for liquid dispensing have been described.

What is claimed is:

1. A method comprising:
installing a device having a container with a liquid at a location:
receiving information related to an amount of said liquid to be dispensed;
starting an injection of an inert gas into said container having said liquid;
stopping said injection of said inert gas when said amount of said liquid to be dispensed has exited said container; and
receiving a payment.

2. The method of claim 1 wherein said exiting is through a spout.

3. The method of claim 2 further comprising measuring said liquid to be dispensed as it passes through said spout and wherein said stopping is based on said measuring.

4. The method of claim 3 further comprising releasing a puff of said inert gas into said spout after said stopping.

5. The method of claim 4 wherein installing said device further comprises receiving an initial payment for said device.

6. The method of claim 4 wherein said receiving said payment is based upon said amount of said liquid dispensed.

7. The method of claim 4 wherein said receiving said payment is based upon an elapsed time since said installing said device.

8. The method of claim 4 wherein said receiving said payment is based upon said amount of said liquid dispensed and an elapsed time since said installing said device.

9. The method of claim 4 wherein said location is a location where said liquid may be consumed.

10. The method of claim 4 wherein said location is selected from the group consisting of a human dwelling, a hotel, a motel, a hostel, a vacation resort, a condominium complex, a cruise chip, a sports complex, a stadium, an arena, a restaurant, a retailer, a winery, and a wine tasting room.

11. An apparatus comprising:
means for installing a device having a container with a liquid at a location;
means for receiving information related to an amount of said liquid to be dispensed;
means for starting an injection of an inert gas into said container having said liquid;
means for stopping said injection of said inert gas when said amount of said liquid to be dispensed has exited said container; and
means for receiving a payment.

12. The apparatus of claim 11 wherein said means for exiting is through a spout.

13. The apparatus of claim 12 further comprising means for measuring said liquid to be dispensed as it passes through said spout and wherein said stopping is based on said measuring.

14. The apparatus of claim 13 further comprising means for releasing a puff of said inert gas into said spout after said stopping.

15. The apparatus of claim 14 wherein means for installing said device further comprises receiving an initial payment for said device.

16. The apparatus of claim 14 wherein said means for receiving said payment is based upon said amount of said liquid dispensed.

17. The apparatus of claim 14 wherein said means for receiving said payment is based upon an elapsed time since said installing said device.

18. The apparatus of claim 14 wherein said means for receiving said payment is based upon said amount of said liquid dispensed and an elapsed time since said installing said device.

19. The apparatus of claim 14 wherein said means for location is a location where said liquid may be consumed.

20. The apparatus of claim 14 wherein said means for location is selected from the group consisting of a human dwelling, a hotel, a motel, a hostel, a vacation resort, a condominium complex, a cruise chip, a sports complex, a stadium, an arena, a restaurant, a retailer, a winery, and a wine tasting room.

21. A wine dispensing unit comprising:
a docking station for receiving a bottle of wine having liquid contents, said docking station having a source of inert gas, a valve assembly and a spout, said valve assembly in gas tight communication with said bottle of wine, said source of inert gas in gas communication with said valve assembly, said spout in liquid communication with said liquid contents, and said spout in gas communication with said source of inert gas;
a user input for receiving information related to an amount of said liquid contents to be dispensed and a payment method for said liquid contents, said received information controlling said valve assembly.
